(19) United States
(12) Patent Application Publication
(10) Pub. No.: US 2025/0124370 A1
(43) Pub. Date: Apr. 17, 2025

(54) System and method for recommending workforce and associated skill set for a task

(71) Applicant: PES UNIVERSITY, Bengaluru (IN)

(72) Inventors: Shashank Lokesh, Bengaluru (IN); Vaishnavi Kruthi Kakkirala, Bangalore (IN); Shreyas Bhaktharam, Bangalore (IN); Sarthak Agarwal, Siliguri (IN)

(21) Appl. No.: 18/486,190

(22) Filed: Oct. 13, 2023

(51) Int. Cl. G06Q 10/0631

(52) U.S. Cl. CPC G06Q 10/063112

(57) ABSTRACT

The present invention discloses a system and method for recommending workforce and associated skillset for a task. The method includes receiving a description of the task from a user along with details of current participants to determine roles associated with the task. Next, the method includes determining skills and required number of candidates for handling the determined roles. Next, the method includes filtering candidates for handling the roles based on the skills and the required number of candidates for determining psychometric qualities of the filtered candidates and current participants. Next, the method includes determining psychometric compatibility score of the filtered candidates with current participants based on corresponding psychometric qualities. Thereafter, the method includes recommending potential team including the filtered candidates based on the psychometric compatibility score and the required number of candidates.

### BACKGROUND

### Technical Field

The present disclosure relates to the field of recommendation tools, and in particular, relates to a system and method for recommending workforce and associated skillset for a task.

### Description of the Related Art

Typically, when a user has an idea or a task in mind that requires collaboration with other individuals, then the user has a tedious task of going through the profiles of many available individuals to find a right set of individuals. However, there are tools available to find right set of candidates based on their skills but the available tools merely perform 1-to-1 comparison of skills of the candidates. However, more often than not, even a team of right skilled people fail to efficiently perform their individual duties to accomplish the task successfully. This is mainly due to the fact that there is significant personality difference between the candidates which disrupts the dynamics of the team, such as the presence of two dominant personalities often leads to difference in opinions and elimination of adjustment required for completing the task.

Thus, there is a need for an improved system and method for recommending workforce and associated skillset for efficiently completing a task while considering psychrometric dynamics of one or more candidates of the workforce.

### BRIEF SUMMARY

One or more embodiments are directed to a system and method for recommending workforce and associated skillset for a task. The system facilitates building a team for executing the task. Initially, the system receives a description of the task as an input for providing the recommendation. The system then parses the received description to determine roles required for the task. Upon determining the roles, the system determines skills that may be essential for handling the determined roles. Based on such determination, the system filters one or more candidate who may be available and may possess the determined skills to take up the determined roles. Then, the system requests the determined one or more candidates and the one or more current users involved in the task to take up a psychometric test to identify their psychometric personality traits, such as Dominant (D), Influential (I), Steady(S), and Conscientiousness (C). Based on the psychometric personality traits and their corresponding scoring, the system identifies a phenotype for each of the determined one or more candidates and their corresponding compatibility score with the one or more current users involved in the task. Further, the system ranks the one or more candidates based on their compatibility scores. Thereafter, the system recommends a suitable team comprising of at least one candidate based on the ranking, the skills, and/or the roles. Accordingly, by using the psychometric compatibility scores, the system recommends potentially the best team of workforce and skillsets for successfully and efficiently completing the task.

An embodiment of the present disclosure discloses the system for recommending workforce and associated skillset for a task. The system includes a receiver module to receive a description of a task from a user along with details of one or more current participants of the task. The received description describes the task in form of text input by the user, selection of one or more option provided to the user, and/or relevant tags inputs by the user. Further, the system includes a role determination module to determine one or more roles associated with the task by parsing the received description. Further, the system includes a skill determination module to determine one or more skills and/or a required number of candidates for handling each of the determined one or more roles. The one or more skills include soft skills, hard skills, and/or psychometric skills.

In some embodiments, the system includes a candidate filter module to filter at least one candidate from one or more candidates for handling the determined one or more roles based on the determined one or more skills and the required number of candidates. The candidate filter module receives skills and interests associated with the one or more candidates for comparing with the determined one or more skills to filter the at least one candidate from the one or more candidates.

In some embodiments, the system includes a psychometric assessment module to determine psychometric qualities of each of the filtered at least one candidate and the received one or more current participants of the task. The psychometric assessment module receives responses of the filtered at least one candidate and the received one or more current participants to a pre-defined number of questions associated with a psychometric test to determine the corresponding psychometric qualities. Further, the psychometric qualities are associated with scores pertaining to one or more traits including Dominant (D), Influential (I), Steady(S), and/or Conscientiousness (C).

In some embodiments, the psychometric assessment module further determines a phenotype of each of the filtered at least one candidate and the received one or more current participants. The phenotype includes a pure phenotype, a composite phenotype, and a dual phenotype. The pure phenotype corresponds to a score difference between a primary trait and a secondary trait is at least 5. The composite phenotype corresponds to a score difference between the primary trait and the secondary trait of less than 5. The dual phenotype corresponds to a score difference between the primary trait and the secondary trait is at most 2.

In some embodiments, the system includes a compatibility module to determine psychometric compatibility score of the filtered at least one candidate with the received one or more current participants based on the determined corresponding psychometric qualities. The compatibility module determines the psychometric compatibility score based on the determined phenotype of each of the filtered at least one candidate and the received one or more current participants. In some embodiments, the compatibility module updates the psychometric compatibility score dynamically when at least one candidate for the task is selected by the user. Further, the compatibility module ranks the filtered at least one candidate based on the determined psychometric compatibility for recommending the potential team. Further, the system includes a recommendation module to recommend a potential team including the filtered at least one candidate based on the determined psychometric compatibility score and the determined required number of candidates.

An embodiment of the present disclosure discloses the method for recommending workforce and associated skillset for a task. The method includes the steps of receiving a description of the task from a user along with details of one or more current participants of the task. Further, the method includes the steps of determining one or more roles associated with the task by parsing the received description. The method also includes the steps of determining one or more skills and/or a required number of candidates for handling each of the determined one or more roles. In some embodiments, the method includes the steps of filtering candidate from one or more candidates for handling the determined one or more roles based on the determined one or more skills and the required number of candidates. Further, the method includes the steps of determining psychometric qualities of each of the filtered at least one candidate and the received one or more current participants of the task. Upon determining the psychometric qualities, the method includes the steps of determining psychometric compatibility score of the filtered at least one candidate with the received one or more current participants based on the determined corresponding psychometric qualities. Thereafter, the method includes the steps of recommending a potential team including the filtered at least one candidate based on the determined psychometric compatibility score and the determined required number of candidates.

In some embodiment, the method further includes the steps of receiving skills and interests associated with the one or more candidates for comparing with the determined one or more skills to filter the at least one candidate from the one or more candidates. In some embodiment, the method further includes the steps of receiving responses from the filtered at least one candidate and the received one or more current participants to a pre-defined number of questions associated with a psychometric test to determine the corresponding psychometric qualities. In some embodiment, the method further includes the steps of determining a phenotype of each of the filtered at least one candidate and the received one or more current participants.

In some embodiment, the method further includes the steps of determining the psychometric compatibility score based on the determined phenotype of each of the filtered at least one candidate and the received one or more current participants. In some embodiment, the method further includes the steps of updating the psychometric compatibility score dynamically when at least one candidate for the task is selected by the user. In some embodiment, the method further includes the steps of ranking the filtered at least one candidate based on the determined psychometric compatibility for recommending the potential team.

The Features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the FIGURES, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of an environment of a system for recommending workforce and associated skillset for a task, in accordance with various embodiments of the present disclosure.

FIG. 2 illustrates a block diagram of the system for recommending workforce and associated skillset for the task, in accordance with various embodiments of the present disclosure.

FIG. 3 illustrates a table showing various combinations of composite phenotypes, in accordance with an embodiment of the present disclosure.

FIGS. 4A-4G illustrate various interfaces of a user device during operation of the system for recommending workforce and associated skillset for a task, in accordance with various embodiments of the present disclosure.

FIG. 5 illustrates a flowchart of a method for recommending workforce and associated skillset for a task, in accordance with an embodiment of the present disclosure.

FIG. 6 illustrates an exemplary computer system in which or with which embodiment of the present disclosure may be utilized.

Other features of embodiments of the present disclosure will be apparent from accompanying drawings and detailed description that follows.

### DETAILED DESCRIPTION

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and thus, are not intended to be limited to any particular named.

A system and method for recommending workforce and associated skillset for a task is disclosed. A user may input details of an idea or a project in mind, looking to collaborate with like-minded individuals or in need of a workforce. Since, most users/people when coming up with their ideas, usually have limited knowledge of the entire field, thus, with the proposed system and method, selecting workforce and skillset required for the project is automated and the time taken for the selection is reduced. Thus, the proposed system helps people make better decisions to form a diverse team with the right skillset to increase the chances of success of a project. The system facilitates building a team for executing the task. Initially, the system receives a description of the task as an input for the providing the recommendation. The system then parses the received description to determine roles required for the task. Upon determining the roles, the system determines skills that may be essential for handling the determined roles. Based on such determination, the system filters one or more candidate who may be available and may possess the determined skills to take up the determined roles. Then, the system requests the filtered one or more candidates and the one or more current users involved in the task to take up a psychometric test to identify their psychometric personality traits, such as Dominant (D), Influential (I), Steady(S), and Conscientiousness (C). Based on the psychometric personality traits and their corresponding scoring, the system identifies a phenotype for each of the determined one or more candidates and their corresponding compatibility score with the one or more current users involved in the task. Further, the system ranks the one or more candidates based on their compatibility scores. Thereafter, the system recommends a suitable team comprising of at least one candidate based on the ranking, the skills, and/or the roles. Accordingly, by using the psychometric compatibility scores, the system recommends potentially the best team of workforce and skillsets for successfully and efficiently completing the task.

The system includes the steps of receiving a description of the task from a user along with details of one or more current participants of the task. Further, the system includes the steps of determining one or more roles associated with the task by parsing the received description. Further, the system includes the steps of determining one or more skills and/or a required number of candidates for handling each of the determined one or more roles. Further, the system includes the steps of filtering at least one candidate from one or more candidates for handling the determined one or more roles based on the determined one or more skills and the required number of candidates. Further, the system includes the steps of determining psychometric qualities of each of the filtered at least one candidate and the received one or more current participants of the task. Further, the system includes the steps of determining psychometric compatibility score of the filtered at least one candidate with the received one or more current participants based on the determined corresponding psychometric qualities. Further, the system includes the steps of recommending a potential team including the filtered at least one candidate based on the determined psychometric compatibility score and the determined required number of candidates.

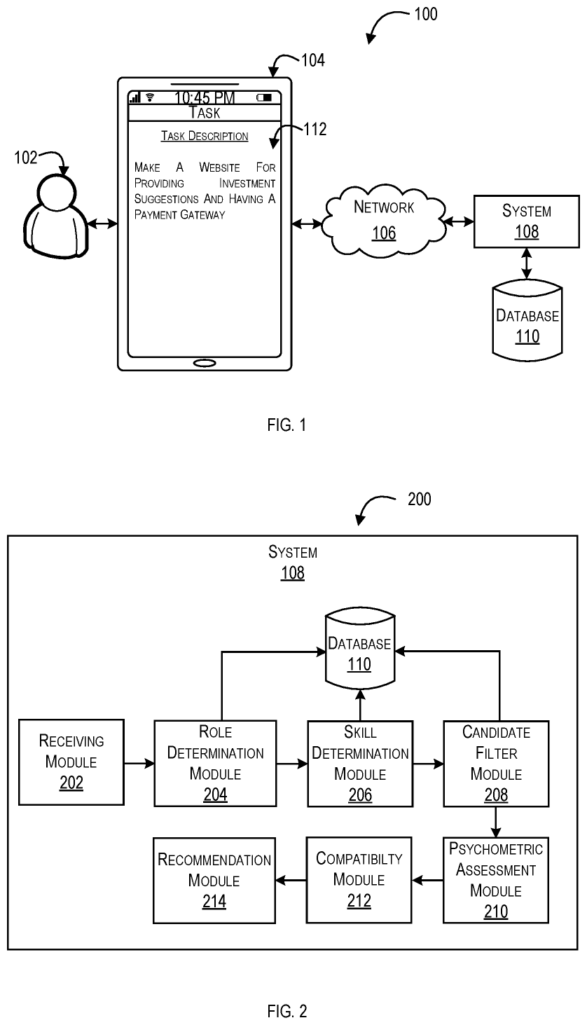

FIG. 1 illustrates a block diagram 100 of an environment of a system 108 for recommending workforce and associated skillset for a task, in accordance with various embodiments of the present disclosure.

The environment may include a user 102, a user device 104, a communication network 106, a system 108, and a database 110. The user 102, for the purpose of the disclosure, may be anyone with an idea or a task or a project in mind and looking for a team or a workforce to implement the task. The user 102 may, without any limitation, be understood as a person, an organization, or a group of people. In an embodiment, the user device 104 may facilitate the user 102 to connect with the system 108 to search for one or more roles and/or skills for performing the task along with the suitable team of one or more candidates to accomplish the task efficiently. The user device 104 may, without any limitation, include a smartphone, a Personal Assistant Device (PDA), a PC, a tablet, a laptop, a smartwatch, and so on. In an embodiment, the user device 104 may include an interface 112 through which the user 102 may input details of the task, make selection of one or more option, and view the potential candidates or a team by the system 108. Further, the communication network 106 may include, without limitation, a direct interconnection, a Local Area Network (LAN), a Wide Area Network (WAN), a wireless network (e.g., using Wireless Application Protocol), the Internet, and the like.

Initially, the system 108 may receive description of the task as an input for the providing the recommendation. The system 108 may then parse the received description to determine roles required for the task. Upon determining the roles, the system 108 may determine skills that may be essential for handling the determined roles. Based on such determination, the system 108 may filter one or more candidate who may be available and may possess the determined skills to take up the determined roles. Then, the system 108 may request the filtered one or more candidates and the one or more current users involved in the task to take up a psychometric test to identify their psychometric personality traits, such as Dominant (D), Influential (I), Steady(S), and Conscientiousness (C). Based on the psychometric personality traits and their corresponding scoring, the system 108 may identify a phenotype for each of the determined one or more candidates and their corresponding compatibility score with the one or more current users involved in the task. Further, the system 108 may rank the one or more candidates based on their compatibility scores. Thereafter, the system 108 may recommend a suitable team comprising of at least one candidate based on the ranking, the skills, and/or the roles.

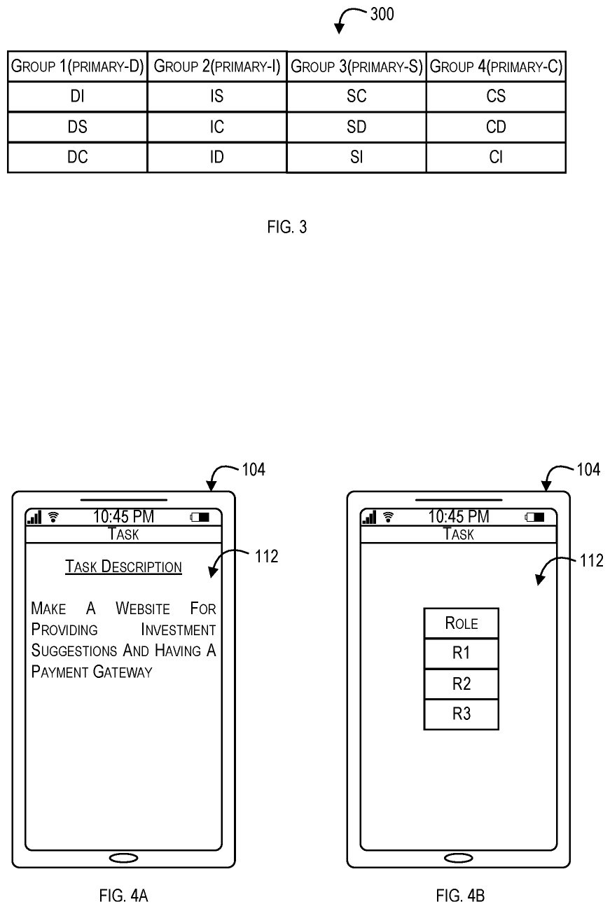

FIG. 2 illustrates a block diagram 200 of the system 108 for recommending workforce and associated skillset for the task, in accordance with various embodiments of the present disclosure.

In some embodiment, the system 108 may include a receiving module 202, a role determination module 204, a skill determination module 206, a candidate filter module 208, a psychometric assessment module 210, a compatibility module 212, a recommendation module 214, and the database 110. The receiving module 202, the role determination module 204, the skill determination module 206, the candidate filter module 208, the psychometric assessment module 210, the compatibility module 212, the recommendation module 214, and the database 110 may be communicatively coupled to the memory and the processor of the system 108.

The processor may control the operations of the receiving module 202, the role determination module 204, the skill determination module 206, the candidate filter module 208, the psychometric assessment module 210, the compatibility module 212, and the recommendation module 214. In an embodiment of the present disclosure, the processor and the memory may form a part of a chipset installed in the system 108. In another embodiment of the present disclosure, the memory may be implemented as a static memory or a dynamic memory. In an example, the memory may be internal to the system 108, such as an onside-based storage. In another example, the memory may be external to the system 108, such as cloud-based storage. Further, the processor may be implemented as one or more microprocessors, microcomputers, digital signal processors, central processing units, state machines, logic circuitries, and/or any devices that manipulate signals based on operational instructions.

In some embodiments, the receiver module 202 may receive a description of the task from the user 102 along with details of one or more current participants of the task. In an embodiment, the user 102 may provide the description in the form of text or written statements. In another embodiment, the user 102 may be provided with options to select and such options may describe the tasks. In an embodiment, the user 102 may input relevant tags describing the task. For example, the description of the task may be “make a website for providing investment suggestions and having a payment gateway”.

In some embodiments, the role determination module 204 may determine one or more roles associated with the task by parsing the received description. In an embodiment, to determine the one or more roles, the role determination module 204 may be communicatively coupled to the database 110 that has a plurality of tasks prestored along with one or more roles corresponding to each of the task. In another embodiment, the role determination module 204 may identify steps required for successfully completing the task based on the received description. Upon identifying the steps, the role determination module 204 may determine roles corresponding to the identified steps. For example, the role determination module 204 may identify one or more steps for making the website for providing investment suggestions having the payment gateway, such as purchasing a web address, designing the website, writing articles related to investment suggestions, and designing a payment gateway.

In some embodiments, the skill determination module 206 may determine one or more skills and a required number of candidates for handling each of the determined one or more roles. The one or more skills may, without any limitation, include soft skills, hard skills, and psychometric skills. In an embodiment, to determine the one or more skills, the skill determination module 206 may be communicatively coupled to the database 110 that has a plurality of roles prestored along with one or more skills corresponding to each of the role. Each role may have multiple software, frameworks and other technologies that are available, such that based on the scale, requirements and context of the task, the best skills that are needed for each role may be determined from around 30,000 different skills. This may be especially useful because the user 102 may not be aware of the technologies used in every single field. In an embodiment, the accuracy of such determination may be measured using hamming loss, with a score of 0.01311, in which, the score may be always between 0 and 1, with a lower score always being better. In one example, if the determined role is to install a tap in kitchen, then the skill may be a hard skill associated with plumbing and one candidate would be enough. In another example, if the determined role is to construct a bed, then the associated skills may be soft skill for designing a bed and hard skill associated with a carpenter while two candidates may be required. In yet another example, if the determine role is build a website, then a soft skill associated with experience in Hypertext Markup Language (HTML) web designing and one candidate may be enough.

In some embodiments, the candidate filter module 208 may filter at least one candidate from one or more candidates for handling the determined one or more roles based on the determined one or more skills and the required number of candidates. In order to filter at least one candidate from the one or more candidates, the candidate filter module 208 may receive skills and interests associated with the one or more candidates for comparing with the determined one or more skills. In an embodiment, to receive skills and interests associated with the one or more candidates, the candidate filter module 208 may be communicatively coupled to the database 110 that has a plurality of candidates prestored along with their associated skills and availability, for example data of all the employees in an organization or resumes of a plurality of candidates with a recruiter.

In another embodiment, to receive skills and interests associated with the one or more candidates, the candidate filter module 208 may post a requirement and the one or more candidates may apply for it. In such a scenario, based on the received description from the user 102, the task may be classified into sectors. In an embodiment, a plurality of sectors with specific tags may be used to automatically tag a task, such that, visibility of the task to candidates that are skilled or interested in the same may be increased. Such sectors and associated tags may be diverse and selected based on field of the task, thus, increasing visibility to the number of candidates and increasing number of interested candidates. Further, role recommendation to form a team may be performed with a categorical accuracy of 63.33%.

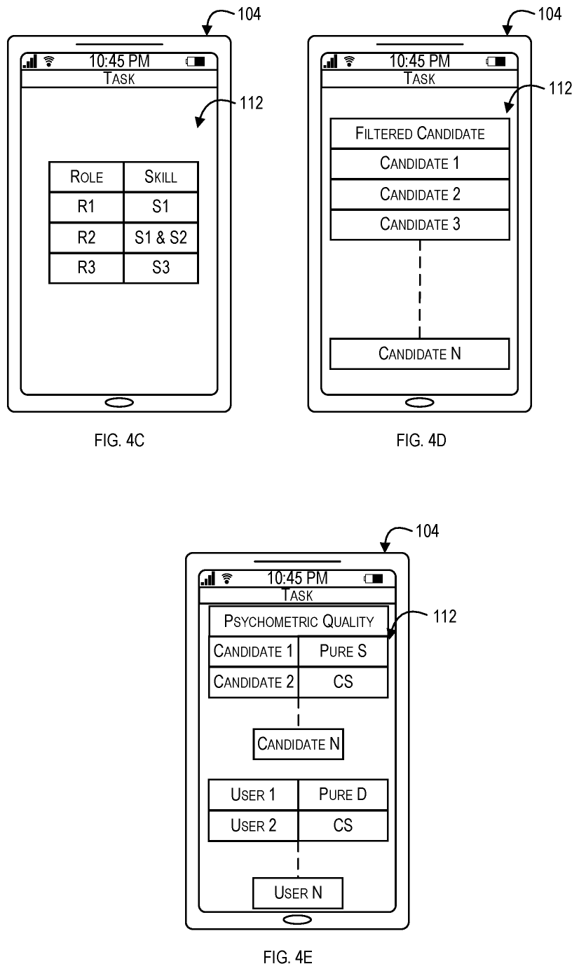

In some embodiments, the psychometric assessment module 210 may determine psychometric qualities of each of the filtered at least one candidate and the received one or more current participants of the task. In order to determine psychometric quality, the psychometric assessment module 210 provides a pre-defined number of questions associated with a psychometric test to the filtered at least one candidate and the received one or more current participants and receive their responses. The psychometric qualities may be associated with scores pertaining to one or more traits including Dominant (D), Influential (I), Steady(S), and/or Conscientiousness (C). In an embodiment, the psychometric assessment module 210 may further determine a phenotype of each of the filtered at least one candidate and the received one or more current participants. The phenotype may, without any limitation, include a pure phenotype, a composite phenotype, and a dual phenotype. The pure phenotype may correspond to a score difference between a primary trait and a secondary trait is at least 5. The composite phenotype may correspond to a score difference between the primary trait and the secondary trait less than 5, as shown in the table 300 in FIG. 3. The dual phenotype may correspond to a score difference between the primary trait and the secondary trait is at most 2. The operation of the psychometric assessment module 210 has been discussed in detail in the following paragraphs.

In some embodiments, the compatibility module 212 may determine psychometric compatibility score of the filtered at least one candidate with the received one or more current participants based on the determined corresponding psychometric qualities. Further, the compatibility module 212 may determine the psychometric compatibility score based on the determined phenotype of each of the filtered at least one candidate and the received one or more current participants. In an embodiment, the compatibility module 212 may further rank the filtered at least one candidate based on the determined psychometric compatibility for recommending the potential team. Accordingly, the compatibility score may be a percentage score that includes skills, roles, and behavior as components.

In an embodiment, the compatibility module 212 may update the psychometric compatibility score dynamically when at least one candidate for the task is selected by the user. For example, consider a situation where a team is to be created for a project having person A as the team leader and therefore the first person within the team. Once the project is posted, let's assume “B”, “C” and “D” may be three candidates who send a request to join A's team. Let's assume that B, C, and D may have a compatibility percentage of 80%, 85%, and 90% respectively with A. Such scores may be a measure of the team compatibility of an individual. However, since there is only 1 person who currently exists in the team, the score may be generated against A. Now, if person A likes person C and decides to take them into the team, person B and person D's compatibility percentage may increase or decrease because the compatibility now may be measured based on individual compatibility against the currently existing team which is person A and person C as well. Thus, the compatibility scores may dynamically change to provide the best possible recommendation of workforce to build a team for a task. The operation of the compatibility module 212 has been discussed in detail in the following paragraphs.

In some embodiments, the recommendation module 214 may recommend a potential team including the filtered at least one candidate based on the determined psychometric compatibility score and the determined required number of candidates. The recommended potential team may be displayed to the user 102 along with suggested role of each candidate along with their corresponding skills.

In operation, for determining the compatibility score, details of the one or more candidates regarding their skills and their interests may be inputted to the system 108. Let's assume there is a person “Roy” who enters their skills as [S1, S2, S3] and their interests as [I1, I2, I3]. Once Roy is onboarded onto the platform, Roy may be asked to take a psychometric test with pre-defined number of questions. The psychometric test may target to gauge qualities of Roy. The qualities may be referred to as DISC where D stands for Dominant, I for Influential, S for Steady, and C for Conscientiousness. One or more techniques, known to a person skilled in the art, may be implemented to gauge the qualities. In an embodiment the test may be provided within the application of the system 108 and may not be a redirect to some other website. Once the test is taken, values of D I S C scores may be received. These scores help the system 108 to identify the phenotype of an individual i.e., what kind of behavior this person exhibits. The values of each of these scores can be between 4-20. For example, let's assume Roy completed the test and got a score of [D-12, I-10, S-15, C-18]. Upon the test and obtaining the scores, the system 108 implements an algorithm that identifies which of these traits are the primary and the secondary traits. Primary trait is the trait with the highest score and the secondary trait is the trait with the second highest score. Once these two are identified, the algorithm assigns the phenotype of the individual. For example, here Roy has C as their primary trait and S as their Secondary trait. Hence, associated phenotype becomes “CS”.

In an embodiment, the phenotype may be defined as a characteristic of an individual that the algorithm assigns to every user based on the results of the test they have taken within the platform. There are three types of Phenotypes, the pure phenotype, composite phenotype, and dual phenotype. The pure phenotypes may be the ones that have a difference of greater than or equal to 5 between their primary and secondary traits. For example, if a person has [D-10, I-8, S-18, C-13], then this person may be categorized as a “PURE S”. Similarly, there may exist a total of 4 pure phenotypes, namely PURE S, PURE I, PURE C and PURE D. The reason they are called PURE types is because they generally tend to express only their dominant trait in almost any sort of scenario presented in the real world. The composite phenotypes may be the ones that have a difference of less than 5 between their primary and secondary traits. They may usually be denoted by their primary and secondary traits written side by side. In the example taken above for Roy, the scores are [D-12, I-10, S-15, C-18]. Hence the associated phenotype is “CS” because of the scores of the primary and secondary traits. In the same way, we have multiple combinations of composite phenotypes. They are divided into 4 groups, as shown below in Table 300 of FIG. 3, based on their primary trait. The reason they are called composite is because of the fact they behave based on both their traits in real-world scenarios. However, they usually behave as per their primary trait more than their secondary trait. The traits at times can have ties. For example, [D-14, I-10, S-10, C-8]. In this situation the primary trait is D, however, the secondary trait has a tie between I and S. To simplify the situation, a priority order may be provided to select the trait. In an embodiment, the priority order may be as follows, S→C→I→D. Hence, in the above example, the phenotype is DS. The same holds true while selecting a tied primary trait, however, with a small change. For example, [D-10, I-15, S-15, C-12]. Here, the primary trait is tied between I and S. By using the above priority order, we choose S as the primary trait. However, the secondary trait is chosen as I, because it still has the highest score overall compared to the next one in the scores list. Hence, the phenotype here is SI. In an embodiment, additional traits, apart from primary traits and secondary traits, may be used to understand a phenotype and human behavior. In an embodiment, neural networks may be used to help make the algorithm immensely better based on user feedback and other metrics/parameters.

In an embodiment, the composite phenotype individuals may express a duality in behavior i.e., the dual phenotype. For example, consider a person “Arun” having a composite phenotype DS. When Arun is put in a group of people, Arun tends to express leadership traits when there was an absence of a leader (a D trait characteristic) and tends to be the calm/steady person who listens to orders when there exists a leader within the group (an S trait characteristic). Based on these results, it may be concluded that Arun has a dual nature wherein Arun may present appropriate traits based on the situation he is put in. In order to characterize the dual phenotype, the system 108 may constantly learn from new data. When the difference of scores of the primary and the secondary trait is within 2, i.e., Primary_trait_score-secondary_trait_score<=2, then the dual phenotype may be identified. For example, [D-14, I-12, S-10, C-8] are scores exhibited by person X. This person may be considered as a DI/ID dual as per the equation stated above instead of a composite phenotype.

It may be understood that each phenotype may have a psychometric compatibility set associated with it. For finding the compatibility score, each phenotype may be measured against the other in terms of psychometric compatibility and they may be quantified as a score. For example, DS-IS: 0.80, DS-Pure D: 0.45, etc. This way, every phenotype may have its own set of items all of which have their corresponding psychometric compatibility. Further, total compatibility score may be shown to the team leader for every person who sends in a request to join their team.

The compatibility score may be calculated using equation given below:

$$Total Compatibility = a \times role\_compat + b \times tot\_skill \_compat + c \times psych\_compat$$

where a, b, and c are all variables.
role_compat=maximum of (skill compatibility of all roles)
tot_skill_compat=percentage of matching skills based on project requirements
psych_compat=score based on psychometric compatibility set.

The variables a, b, and c may be dynamically shifting based on multiple parameters. All the psychometric compatibility sets together make up the psychometric compatibility matrix. The psychometric compatibility set may be constantly updated via a neural network that takes in customer insights, feedback, team capabilities, and team deliverables. Considering an example, a person “OP” be the person posting a team requirement and let “T” be a set with the current team members. While creating the post, OP needs to add in the roles r1, r2, r3, and skills [s1, s2, s3], [s4, s5, s6], [s7, s8, s9] respectively for each role. Once the post has been created, the first member of T is OP. Hence, T=[“OP”]. Let's assume P1, P2 and P3 are three people who send a request to OP for their team T for the role r1, r2, and r3 which requires skills as mentioned above. Let the scores for P1-T[r1] (compatibility between P1 and T)=85%, P2-T[r2] (compatibility between P2 and T)=90%, and P3-T[r3] (compatibility between P3 and T)=87%.

Now, let's assume that OP likes P2's profile and wants them on the team T. The moment P2 is accepted into the team, the team now consists of T=[OP, P2]. Now, for the remaining requests P1-T[r1], and P3-T[r3] their compatibility score needs to be recalculated against T because the composition of T has changed. This is done by first taking an intersection set of the psychometric compatibility sets of P2 and OP. The resulting set acts as the compatibility set for T. Here, only the highest scores that are achieved as a result of the intersection are taken so as to avoid conflicts. Now the new compatibilities could be, P1-T[r1] (compatibility between P1 and T)=88%, and P3-T[r3] (compatibility between P3 and T)=81%. Here we see a change in score because the compatibility values of P1 and P3 with T has changed because of P2 being added to the team T. The concept carries forward with every new team member being added. In an embodiment, when any of these people are present as a Dual, then the system always considers the part of the dual having higher compatibility against the team they are trying to join and also the same when they are already within the team. For example, DI/ID dual is the phenotype of a person P5, that has sent a request to team T1. Now assume, P5 (ID)-T (compatibility of P5, as an ID phenotype, with T)=85%, and P5 (DI)-T (compatibility of P5, as a DI phenotype, with T)=70%.

In the above situation, person P5's ID will be taken as the score of choice and presented to users so as to maximize their chance of getting into the team. By recommending the workforce and skill set as proposed, the system 108 may provide subjective analysis of one individual, subjective analysis of a group of people and also subjective compatibility between two people. Further, objective compatibility may be provided between many individuals to form a group of people who for any given task can maximize their output as a team. This helps in maximizing the fit of the group that is selected from a random pool of humans based on our own psychometric and behavioral analysis. Objective scores are provided to help people make informed decisions on who they take into their teams rather than the traditional gut feeling based process. Further, the system 108 may constantly improve accuracy using an auto tagging system, role and skill recommender to help people with no prior knowledge about the field, to easily understand what kind of roles are needed for their team to be successful, saving research time and manual efforts. The compatibility score determined using the system 108 makes use of behavior, skills and role fit within a team. The psychometric compatibility Matrix is developed with many parameters to determine the compatibility score. Speed and ease of choosing teammates and creating a great team with this compatibility score is achieved. Auto-tagging of a project may be based simply on the title and description. Recommendation of roles needed for the project, assignment or task may be based on the description. Set of hard/soft skills required for each role may also recommended.

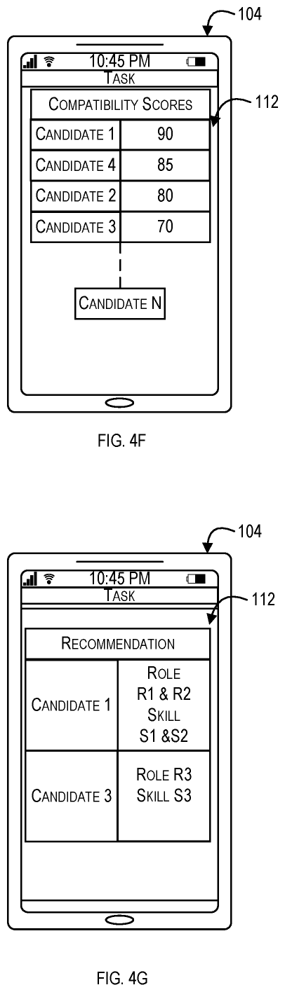

FIGS. 4A-4G illustrate various interfaces 112 of the user device 104 during operation of the system 108 for recommending workforce and associated skillset for a task, in accordance with various embodiments of the present disclosure.

Initially, the system 108 may receive a description of the task from a user 102 along with details of one or more current participants of the task, as shown in FIG. 4A. Upon receiving the description, the system 108 may determine one or more roles associated with the task by parsing the received description, as shown in FIG. 4B. Then, the system 108 may determine one or more skills and a required number of candidates for handling each of the determined one or more roles, as shown in FIG. 4C. Upon determining the one or more skills, the system 108 may filter at least one candidate from one or more candidates for handling the determined one or more roles based on the determined one or more skills and the required number of candidates, as shown in FIG. 4D. Then, the system 108 may determine psychometric qualities of each of the filtered at least one candidate and the received one or more current participants of the task, as shown in FIG. 4E. Upon determining the psychometric qualities, the system 108 may determine psychometric compatibility score of the filtered at least one candidate with the received one or more current participants based on the determined corresponding psychometric qualities, as shown in FIG. 4F. Thereafter, the system 108 may recommend a potential team including the filtered at least one candidate based on the determined psychometric compatibility score and the determined required number of candidates, as shown in FIG. 4G.

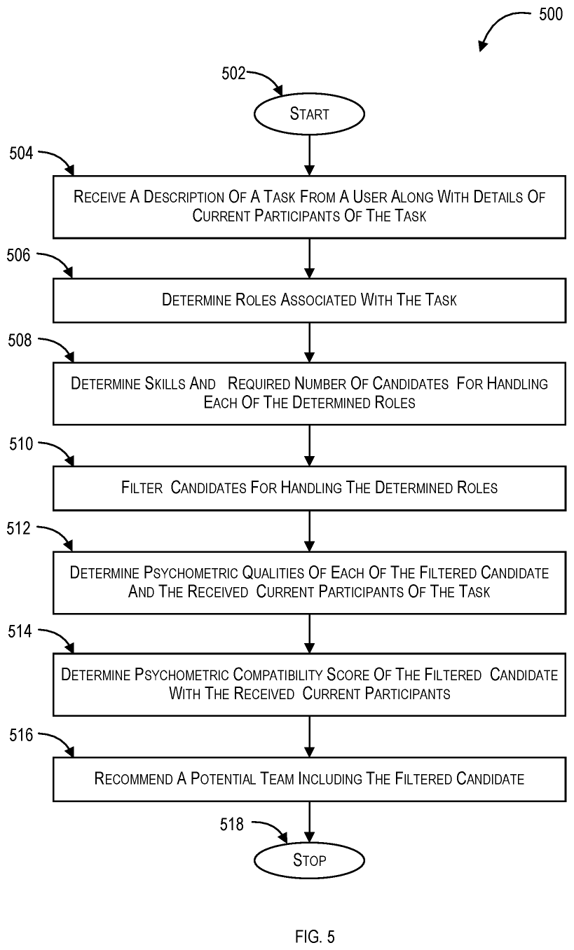

FIG. 5 illustrates a flowchart 500 of a method for recommending workforce and associated skillset for a task, in accordance with an embodiment of the present disclosure. The method starts at step 502.

At first, at step 504, a description of the task may be received from a user along with details of one or more current participants of the task. The description may describe the task and may be received in the form of text input by the user, selection of one or more option provided to the user, relevant tags inputs by the user, or a combination thereof.

Further, at step 506, one or more roles associated with the task may be determined by parsing the received description. Further, at step 508, one or more skills and/or a required number of candidates for handling each of the determined one or more roles may be determined. The one or more skills may include soft skills, hard skills, and psychometric skills.

Further, at step 510, at least one candidate from one or more candidates for handling the determined one or more roles may be filtered based on the determined one or more skills and the required number of candidates. The method may include the steps of receiving skills and interests associated with the one or more candidates for comparing with the determined one or more skills to filter the at least one candidate from the one or more candidates.

After that, at step 512, psychometric qualities of each of the filtered at least one candidate and the received one or more current participants of the task may be determined. The method may include the steps of receiving responses of the filtered at least one candidate and the received one or more current participants to a pre-defined number of questions associated with a psychometric test to determine the corresponding psychometric qualities. In an embodiment, the psychometric qualities may be associated with scores pertaining to one or more traits including, without any limitation, Dominant (D), Influential (I), Steady(S), and Conscientiousness (C). The method may further include the steps of determining a phenotype of each of the filtered at least one candidate and the received one or more current participants. Further, the phenotype may, without any limitation, include a pure phenotype, a composite phenotype, and a dual phenotype. The pure phenotype may correspond to a score difference between a primary trait and a secondary trait is at least 5. The composite phenotype may correspond to a score difference between the primary trait and the secondary trait less than 5. The dual phenotype may correspond to a score difference between the primary trait and the secondary trait is at most 2

After that, at step 514, psychometric compatibility score of the filtered at least one candidate with the received one or more current participants may be determined based on the determined corresponding psychometric qualities. The method may further include the steps of determining the psychometric compatibility score based on the determined phenotype of each of the filtered at least one candidate and the received one or more current participants. Further, the method may include the steps of updating the psychometric compatibility score dynamically when at least one candidate for the task is selected by the user and ranking the filtered at least one candidate based on the determined psychometric compatibility for recommending the potential team.

Thereafter, at step 516, a potential team including the filtered at least one candidate may be recommended based on the determined psychometric compatibility score and the determined required number of candidates. The method ends at step 518.

The method may be utilized within the app to help users to create teams and measure compatibility amongst each other and help make it easier for users to find who is needed for their teams. Automatic classification of projects increases the visibility of interested candidates. In an embodiment, social networking sites and communities might also use the method for determining the compatibility score within team formation. Other job portal and freelancer sites may use the method for automatic tagging and reduction of manual intervention within their own platforms. In an embodiment, the method may be used for other use cases such as Matrimony matchmaking, hiring, and creating a team/group of people who aim to do a particular task in any field regardless of age, country, gender, or orientation. In an embodiment, the method may be improved upon by adding many more tests for users to improve the algorithm. Any field that involves two or more people networking/connecting, both offline and online, may utilize the method. The working of the method may improve the accuracy of the recommendation model to serve niche sectors such as agriculture, astronomy and many others over a period of time. A re-learning algorithm may be implemented to take user feedback from the method to not only improve the suggestions but also add other roles and tags that were previously not considered. The method may be improved by considering many more parameters such as age group, behavior, current skills etc. to make it a much more improved method for recommendation of roles and skills based on the project details. The method may also create a job time/job effort prediction system using the same parameters to help project owners and teammates to know how much time it may take to complete a project.

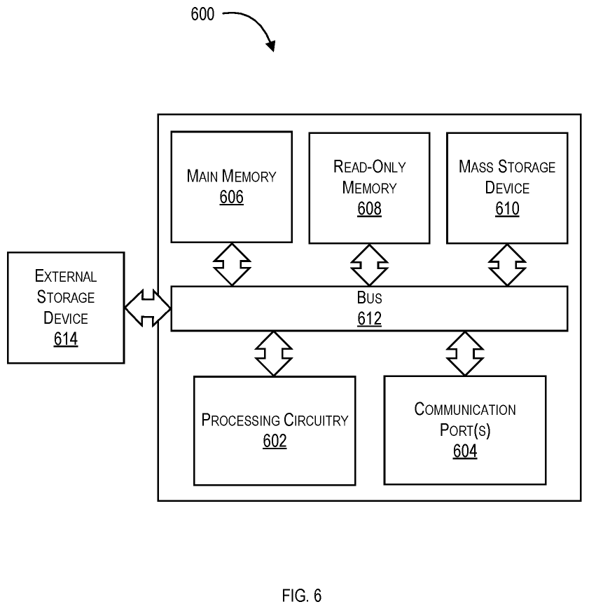

FIG. 6 illustrates an exemplary computer system in which or with which embodiment of the present disclosure may be utilized. As shown in FIG. 6, a computer system 600 includes an external storage device 614, a bus 612, a main memory 606, a read-only memory 608, a mass storage device 610, a communication port 604, and a processor 602.

Those skilled in the art will appreciate that computer system 600 may include more than one processor 602 and communication ports 604. Examples of processor 602 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 602 may include various modules associated with embodiments of the present disclosure.

Communication port 604 can be any of an RS-232 port for use with a modem-based dialup connection, a 10/100 Ethernet port, a Gigabit or 10 Gigabit port using copper or fiber, a serial port, a parallel port, or other existing or future ports. Communication port 604 may be chosen depending on a network, such as a Local Area Network (LAN), Wide Area Network (WAN), or any network to which the computer system 600 connects.

Memory 606 can be Random Access Memory (RAM), or any other dynamic storage device commonly known in the art. Read-Only Memory 608 can be any static storage device(s) e.g., but not limited to, a Programmable Read-Only Memory (PROM) chips for storing static information e.g., start-up or BIOS instructions for processor 602.

Mass storage 610 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 612 communicatively couples processor(s) 602 with the other memory, storage, and communication blocks. Bus 612 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 602 to a software system.

Optionally, operator and administrative interfaces, e.g., a display, keyboard, and a cursor control device, may also be coupled to bus 612 to support direct operator interaction with the computer system. Other operator and administrative interfaces can be provided through network connections connected through communication port 604. An external storage device 614 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

We claim:

1. A system for recommending workforce and associated skillset for a task, the system comprising:
a receiver module to receive a description of a task from a user along with details of one or more current participants of the task;
a role determination module to determine one or more roles associated with the task by parsing the received description;
a skill determination module to determine at least one of: one or more skills and a required number of candidates for handling each of the determined one or more roles;
a candidate filter module to filter at least one candidate from one or more candidates for handling the determined one or more roles based on the determined one or more skills and the required number of candidates;
a psychometric assessment module to determine psychometric qualities of each of the filtered at least one candidate and the received one or more current participants of the task;
a compatibility module to determine psychometric compatibility score of the filtered at least one candidate with the received one or more current participants based on the determined corresponding psychometric qualities; and
a recommendation module to recommend a potential team including the filtered at least one candidate based on the determined psychometric compatibility score and the determined required number of candidates.

2. The system of claim 1, wherein the description describes the task and is received in form of at least one of: text input by the user, selection of one or more option provided to the user, and relevant tags inputs by the user.

3. The system of claim 1, wherein the one or more skills include at least one of: soft skills, hard skills, and psychometric skills.

4. The system of claim 1, wherein the candidate filter module receives skills and interests associated with the one or more candidates for comparing with the determined one or more skills to filter the at least one candidate from the one or more candidates.

5. The system of claim 1, wherein the psychometric assessment module receives responses of the filtered at least one candidate and the received one or more current participants to a pre-defined number of questions associated with a psychometric test to determine the corresponding psychometric qualities.

6. The system of claim 1, wherein the psychometric qualities is associated with scores pertaining to one or more traits including at least one of: Dominant (D), Influential (I), Steady(S), and Conscientiousness (C).

7. The system of claim 6, wherein the psychometric assessment module further determines a phenotype of each of the filtered at least one candidate and the received one or more current participants.

8. The system of claim 7, wherein the phenotype includes:
a pure phenotype corresponding to a score difference between a primary trait and a secondary trait is at least 5;
a composite phenotype corresponding to a score difference between the primary trait and the secondary trait less than 5; and
a dual phenotype corresponding to a score difference between the primary trait and the secondary trait is at most 2.

9. The system of claim 7, wherein the compatibility module determines the psychometric compatibility score based on the determined phenotype of each of the filtered at least one candidate and the received one or more current participants.

10. The system of claim 1, wherein the compatibility module updates the psychometric compatibility score dynamically when at least one candidate for the task is selected by the user.

11. The system of claim 1, wherein the compatibility module further ranks the filtered at least one candidate based on the determined psychometric compatibility for recommending the potential team.

12. A method for recommending workforce and associated skillset for a task, the method comprising:
receiving a description of the task from a user along with details of one or more current participants of the task;
determining one or more roles associated with the task by parsing the received description;
determining at least one of: one or more skills and a required number of candidates for handling each of the determined one or more roles;
filtering at least one candidate from one or more candidates for handling the determined one or more roles based on the determined one or more skills and the required number of candidates;
determining psychometric qualities of each of the filtered at least one candidate and the received one or more current participants of the task;
determining psychometric compatibility score of the filtered at least one candidate with the received one or more current participants based on the determined corresponding psychometric qualities; and
recommending a potential team including the filtered at least one candidate based on the determined psychometric compatibility score and the determined required number of candidates.

13. The method of claim 12,
wherein the description describes the task and is received in form of at least one of: text input by the user, selection of one or more option provided to the user, and relevant tags inputs by the user; and
wherein the one or more skills include at least one of: soft skills, hard skills, and psychometric skills.

14. The method of claim 12, further comprises receiving skills and interests associated with the one or more candidates for comparing with the determined one or more skills to filter the at least one candidate from the one or more candidates.

15. The method of claim 12, further comprises receiving responses of the filtered at least one candidate and the received one or more current participants to a pre-defined number of questions associated with a psychometric test to determine the corresponding psychometric qualities.

16. The method of claim 12, wherein the psychometric qualities is associated with scores pertaining to one or more traits including at least one of: Dominant (D), Influential (I), Steady(S), and Conscientiousness (C).

17. The method of claim 16, further comprises determining a phenotype of each of the filtered at least one candidate and the received one or more current participants.

18. The method of claim 17, wherein the phenotype includes:
a pure phenotype corresponding to a score difference between a primary trait and a secondary trait is at least 5;
a composite phenotype corresponding to a score difference between the primary trait and the secondary trait less than 5; and
a dual phenotype corresponding to a score difference between the primary trait and the secondary trait is at most 2.

19. The method of claim 17, further comprises determining the psychometric compatibility score based on the determined phenotype of each of the filtered at least one candidate and the received one or more current participants.

20. The method of claim 12, further comprises
updating the psychometric compatibility score dynamically when at least one candidate for the task is selected by the user; and
ranking the filtered at least one candidate based on the determined psychometric compatibility for recommending the potential team.
